(19) United States
(12) Patent Application Publication
(10) Pub. No.: US 2026/0092006 A1
(43) Pub. Date: Apr. 2, 2026

(54) NOVEL PRECAST MASONRY UNITS WITH CO2 CURING USING ALTERNATIVE CEMENTITIOUS MATERIALS

(71) Applicant: TEXAS STATE UNIVERSITY, San Marcos, TX (US)

(72) Inventors: Muhammed Bayram, San Marcos, TX (US); Togay Ozbakkaloglu, New Braunfels, TX (US)

(73) Assignee: TEXAS STATE UNIVERSITY, San Marcos, TX (US)

(21) Appl. No.: 19/284,761

(22) Filed: Jul. 30, 2025

Related U.S. Application Data
(60) Provisional application No. 63/700,642, filed on Sep. 28, 2024.

(51) Int. Cl. C04B 7/32; C04B 14/04; C04B 14/06; C04B 14/30; C04B 18/06; C04B 24/06; C04B 28/06; C04B 40/02; C04B 103/20; C04B 111/00

(52) U.S. Cl. CPC C04B 7/323; C04B 14/043; C04B 14/06; C04B 14/304; C04B 18/067; C04B 24/06; C04B 28/065; C04B 40/0231; C04B 2103/20; C04B 2111/00019

(57) ABSTRACT

The present disclosure pertains to a cement mixture that includes calcium sulfoaluminate (CSA) and an additive. The additive may include, without limitation, magnesium oxide (MgO), ground granulated blast-furnace slag (GGBFS), wollastonite, and combinations thereof. The present disclosure also pertains to a cementitious material that includes a cement mixture of the present disclosure. Further embodiments of the present disclosure pertain to methods of forming a cementitious material by (1) mixing CSA with an additive of the present disclosure to form a mixture; and (2) curing the mixture.

### CROSS-REFERENCE TO RELATED APPLICATIONS

This application claims priority to U.S. Provisional Patent Application No. 63/700,642, filed on Sep. 28, 2024. The entirety of the aforementioned application is incorporated herein by reference.

### BACKGROUND

A need exists for more sustainable, efficient and environmentally friendly methods of producing concrete. A need also exists for more durable concrete products. Numerous embodiments of the present disclosure aim to address the aforementioned needs.

### SUMMARY

In some embodiments, the present disclosure pertains to a cement mixture that includes calcium sulfoaluminate (CSA) and an additive. In some embodiments, the additive includes, without limitation, magnesium oxide (MgO), ground granulated blast-furnace slag (GGBFS), wollastonite, and combinations thereof.

Additional embodiments of the present disclosure pertain to a cementitious material that includes a cement mixture of the present disclosure. In some embodiments, the cementitious materials of the present disclosure may be in the form of mortars, concrete, precast masonry units, or combinations thereof.

Further embodiments of the present disclosure pertain to methods of forming a cementitious material by (1) mixing CSA with an additive to form a mixture; and (2) curing the mixture. In some embodiments, the additive includes, without limitation, MgO, GGBFS, wollastonite, and combinations thereof. In some embodiments, the curing occurs in the presence of carbon dioxide (CO₂).

### BRIEF DESCRIPTION OF DRAWINGS

FIGS. 1A-1C provide illustrations of materials and mix preparations of calcium sulfoaluminate (CSA)-ground granulated blast-furnace slag (GGBFS), CSA-Wollastonite and CSA-magnesium oxide (MgO) masonry units.

FIG. 2 provides flow spread results for CSA-GGBFS mixtures at varying replacement levels, measured using American Society for Testing and Materials (ASTM) C1437.

FIG. 3 provides flow spread results for CSA-Wollastonite mixtures at varying replacement levels, measured using ASTM C1437.

FIG. 4 provides flow spread results for CSA-MgO mixtures using two reactivity levels (M30 and M50), measured using ASTM C1437.

FIGS. 5A-5C provide compressive strength of CSA-GGBFS mortars under different curing regimes (water, 5% CO₂, and 20% CO₂).

FIGS. 6A-6C provide compressive strength of CSA-Wollastonite mortars under different curing regimes (water, 5% CO₂, and 20% CO₂).

FIGS. 7A-7C provide compressive strength of CSA-MgO mortars (M30 and M50) under different curing regimes (water, 5% CO₂, and 20% CO₂).

FIGS. 8A-8B provide residual compressive strength of CSA-GGBFS mortars after exposure to 100° C., 300° C., and 700° C., comparing specimens cured under different curing regimes (water, 5% CO₂, and 20% CO₂).

FIGS. 9A-9B provide residual compressive strength of CSA-Wollastonite mortars after exposure to 100° C., 300° C., and 700° C., comparing specimens cured under different curing regimes (water, 5% CO₂, and 20% CO₂).

FIGS. 10A-10C provide residual compressive strength of CSA-MgO mortars (M30 and M50) after exposure to 100° C., 300° C., and 700° C., comparing specimens cured under different curing regimes (water, 5% CO₂, and 20% CO₂).

FIGS. 11A-11C provide thermogravimetric analysis (TGA) and derivative thermogravimetric (DTG) results of water-cured CSA mortars with GGBFS under different curing regimes (water and 20% CO₂).

FIGS. 12A-12C provide TGA and DTG results of CSA mortars with Wollastonite under different curing regimes (water and 20% CO₂).

FIGS. 13A-13C provide TGA and DTG results of CSA mortars with MgO under different curing regimes (water and 20% CO₂).

FIG. 14 provides Global Warming Potential (GWP), CO₂ uptake, and net GWP (kg CO₂ eq) for all mixes based on cradle-to-gate life cycle assessment (LCA).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

With a service history surpassing two centuries, cement, particularly Portland cement, has established itself as a dependable construction material, exhibiting reliability across a broad spectrum of working and environmental conditions. The success of Portland cement is evidenced by the widespread production of Portland cement concrete, making it the most manufactured material globally. The global production of cement reached an estimated 4.1 billion metric tons in 2020, and forecasts from the World Cement Association suggest a substantial increase to 8.2 billion ton by the year 2030.

As a consequence of the substantial surge in cement demand, the proportion of cement production to overall anthropogenic carbon dioxide (CO₂) emissions has been consistently increasing. Certain sources currently approximate this percentage to fall within the range of about 6% to 10%, contributing to the overall anthropogenic greenhouse gases (GHG). Despite the cement industry making significant progress in both production efficiency and emission reduction efforts since the 1970s, this trend has still persisted. For instance, the production of Ordinary Portland Cement (OPC) results in an average emission of 842 kg of CO₂ per ton of clinker. Fossil fuel combustion accounts for less than 40% of the total CO₂ emissions, with the remaining portion attributed to limestone decomposition (CaCO₃ or CaO·CO₂) during the calcination process.

Recent scientific reports indicate that, to align with the goals of the Paris Agreement, the world must achieve net-zero emissions by the conclusion of this century. Achieving this vision necessitates the rapid development and implementation of strategies aimed at reducing CO₂ emissions, organized into four key areas: enhancing energy efficiency, transitioning to alternative fuels with lower carbon intensity, lowering the clinker-to-cement ratio, and integrating carbon capture into cement production.

In sum, a need exists for more sustainable, efficient and environmentally friendly methods of producing concrete. In particular, traditional cement production methods are not environmentally friendly and yield large amounts of CO₂, thereby contributing to a massive carbon footprint. A need also exists for more durable concrete products. For instance, precast cement requires exceptionally high early stage strength to meet durability requirements, though it often experiences performance limitations. Numerous embodiments of the present disclosure aim to address the aforementioned needs.

In some embodiments, the present disclosure pertains to a cement mixture that includes calcium sulfoaluminate (CSA) and an additive. In some embodiments, the additive includes, without limitation, magnesium oxide (MgO), ground granulated blast-furnace slag (GGBFS), wollastonite, and combinations thereof. Additional embodiments of the present disclosure pertain to a cementitious material that includes a cement mixture of the present disclosure.

Further embodiments of the present disclosure pertain to methods of forming a cementitious material by (1) mixing CSA with an additive to form a mixture; and (2) curing the mixture. In some embodiments, the additive includes, without limitation, MgO, GGBFS, wollastonite, and combinations thereof.

As set forth in more detail herein, the cement mixtures, cementitious materials, and cementitious material formation methods of the present disclosure can have numerous embodiments.

### Calcium Sulfoaluminate (CSA)

The cement mixtures and cementitious materials of the present disclosure can include CSAs at various concentrations. Additionally, the cementitious material formation methods of the present disclosure can mix CSAs with additives at various concentrations. For instance, in some embodiments, CSA concentrations may range from about 60 wt. % to less than about 100 wt. %. In some embodiments, CSA concentrations may be at least about 60 wt. %. In some embodiments, CSA concentrations may be at least about 70 wt. %. In some embodiments, CSA concentrations may be at least about 80 wt. %. In some embodiments, CSA concentrations may be at least about 90 wt. %.

### Additives

The cement mixtures and cementitious materials of the present disclosure can include various additives at various concentrations. Additionally, the cementitious material formation methods of the present disclosure can mix various additives at various concentrations. For instance, in some embodiments, the additives include, without limitation, magnesium oxide (MgO), ground granulated blast-furnace slag (GGBFS), wollastonite, and combinations thereof.

In some embodiments, additives include MGO. In some embodiments, the MgO may be light-burned and available in varying levels of reactivity. In some embodiments, the MgO may be present in a mixture at a concentration ranging from more than 0 wt. % to about 40 wt. %. In some embodiments, the MgO may be present in a mixture at a concentration of at least about 10 wt. %. In some embodiments, the MgO may be present in a mixture at a concentration of at least about 20 wt. %. In some embodiments, the MgO may be present in a mixture at a concentration of at least about 30 wt. %. In some embodiments, the MgO may be present in a mixture at a concentration of at least about 40 wt. %.

The MGOs of the present disclosure can have various surface areas. For instance, in some embodiments, the MgO includes surface areas ranging from about 10 m²/g to about 60 m²/g. In some embodiments, the MgO includes surface areas of at least about 10 m²/g. In some embodiments, the MgO includes surface areas of at least about 20 m²/g. In some embodiments, the MgO includes surface areas of at least about 30 m²/g. In some embodiments, the MgO includes surface areas of at least about 40 m²/g. In some embodiments, the MgO includes surface areas of at least about 50 m²/g. In some embodiments, the MgO includes surface areas of at least about 60 m²/g.

In some embodiments, the additives include GGBFS. In some embodiments, the GGBFS may be present in a mixture at a concentration ranging from about 10 wt. % to about 30 wt. %. In some embodiments, the GGBFS may be present in a mixture at a concentration of at least about 10 wt. %. In some embodiments, the GGBFS may be present in a mixture at a concentration of at least about 20 wt. %. In some embodiments, the GGBFS may be present in a mixture at a concentration of at least about 30 wt. %.

In some embodiments, the additives include wollastonite. In some embodiments, the wollastonite may be present in a mixture at a concentration ranging from about 10 wt. % to about 30 wt. %. In some embodiments, the wollastonite may be present in a mixture at a concentration of at least about 10 wt. %. In some embodiments, the wollastonite may be present in a mixture at a concentration of at least about 20 wt. %. In some embodiments, the wollastonite may be present in a mixture at a concentration of at least about 30 wt. %.

### Aggregate Materials

In some embodiments, the cement mixtures and cementitious materials of the present disclosure can also include one or more aggregate materials. In some embodiments, the cementitious material formation methods of the present disclosure also include a step of mixing a mixture with one or more aggregate materials.

The cement mixtures and cementitious materials of the present disclosure can include various aggregate materials. Moreover, the cementitious material formation methods of the present disclosure can mix a mixture with various aggregate materials.

For instance, in some embodiments, the aggregate materials include, without limitation, sand, gravel, crushed stone, or combinations thereof. In some embodiments, the aggregate materials include sand. In some embodiments, the sand includes particle size distributions ranging from about 1.2 mm to about 100 μm.

Aggregate materials may be mixed with a cementitious material mixture at various ratios. For instance, in some embodiments, aggregate materials may be mixed with a mixture at aggregate material to mixture ratios of 1.5 to 3.0.

In some embodiments, the cementitious material formation methods of the present disclosure also include a step of mixing a mixture with one or more aggregate materials in the presence of water. For instance, in some embodiments, aggregate materials may be mixed with a mixture at water to aggregate material ratios of 0.4 to 06. In some embodiments, such ratios may be selected to ensure consistent workability and mechanical performance, and to isolate the influence of the additives.

### Cement Retarders

In some embodiments, the cement mixtures and cementitious materials of the present disclosure can also include one or more cement retarders. In some embodiments, the cementitious material formation methods of the present disclosure also include a step of mixing a mixture with one or more cement retarders.

The cement mixtures and cementitious materials of the present disclosure can include various cement retarders at various concentrations. Moreover, the cementitious material formation methods of the present disclosure can mix a mixture with various cement retarders at various concentrations.

For instance, in some embodiments, the cement retarders include, without limitation, lignosulfonates, hydroxycarboxylic acids, phosphonates, sugars, starches, citric acid, anhydrous citric acid, or combinations thereof. In some embodiments, the cement retarders include citric acid, such as anhydrous citric acid. In some embodiments, the cement retarders may be present in a mixture at a concentration ranging from about 0.1 wt. % to about 1.0 wt. %. In some embodiments, the cement retarders may be present in a mixture at a concentration of at least about 0.1 wt. %. In some embodiments, the cement retarders may be present in a mixture at a concentration of at least about 0.5 wt. %. In some embodiments, the cement retarders may be present in a mixture at a concentration of at least about 1 wt. %.

Cement retarders may be mixed with a cementitious material mixture at various ratios. For instance, in some embodiments, cement retarders may be mixed with water-to-CSA and aggregate material-to-CSA ratios ranging from about 0.4 to 0.6 and 1.5 to 2.5, respectively.

### Curing of Cementitious Material Mixtures

Various methods may be utilized to cure the cementitious material mixtures of the present disclosure. For instance, in some embodiments, the curing includes heating the mixture. In some embodiments, the curing occurs at room temperature. In some embodiments, the curing occurs in the presence of carbon dioxide (CO₂). In some embodiments, the CO₂ concentration is at least about 0.5%. In some embodiments, the CO₂ concentration is at least about 1%. In some embodiments, the CO₂ concentration is at least about 5%. In some embodiments, the CO₂ concentration is at least about 10%. In some embodiments, the CO₂ concentration is at least about 15%. In some embodiments, the CO₂ concentration ranges from about 5% to about 20%.

Curing may occur for various periods of time. For instance, in some embodiments, the curing occurs from about 1 day to about 28 days. In some embodiments, the curing occurs for at least about 1 day. In some embodiments, the curing occurs for at least about 3 days. In some embodiments, the curing occurs for at least about 7 days. In some embodiments, the curing occurs for at least about 28 days.

In some embodiments, the curing process involves exposing a mixture to an environment enriched with CO₂, such as in a curing chamber with controlled temperature, humidity, and CO₂ concentrations ranging from about 5% to 20%. In some embodiments, the curing may optionally include elevated temperatures or pressurization to enhance carbonation efficiency.

### Cementitious Material Formation Applications

The cementitious material formation methods of the present disclosure can include various applications. For instance, in some embodiments, the methods of the present disclosure may be used to capture CO₂ from an environment. In some embodiments, the methods of the present disclosure may be used to reduce greenhouse gas emissions in various industries, such as the construction industry.

### Cement Mixture States and Forms

The Cement Mixtures of the Present Disclosure May be in Various States and Forms. For instance, in some embodiments, the cement mixtures of the present disclosure may be in a precured form. In some embodiments, the cement mixtures of the present disclosure may be a component of Portland cement.

### Cementitious Material Forms

The cementitious materials of the present disclosure may also be in various states and forms. For instance, in some embodiments, the cementitious materials of the present disclosure may be in cured form. In some embodiments, the cementitious materials of the present disclosure may be in the form of mortars, concrete, precast masonry units, or combinations thereof.

### Additional Embodiments

Reference will now be made to more specific embodiments of the present disclosure and experimental results that provide support for such embodiments. However, Applicant notes that the disclosure herein is for illustrative purposes only and is not intended to limit the scope of the claimed subject matter in any way.

This Example presents a novel approach to manufacturing concrete masonry units tailored for precast industry applications, with a focus on reducing carbon emissions, enhancing early-age strength, and improving long-term durability. The cementitious system is based on CSA cement, which is combined with one or more mineral additives, including reactive MgO, GGBFS, and wollastonite. These materials are selected for their distinct chemical reactivity, particle morphology, and environmental advantages. The proposed formulation enables CO₂-curing compatibility, facilitates carbon sequestration, and addresses key performance challenges associated with conventional binders. This Example explores a range of replacement levels and additive types to optimize the balance between mechanical performance, carbonation potential, and sustainability for precast concrete production.

Through comprehensive experimentation and multi-scale characterization, this Example demonstrates significant improvements in both environmental sustainability and material performance. The evaluation program includes flow table tests to assess workability, and mechanical testing for compressive strength development under various CO₂ curing conditions. Additional durability assessment included resistance to high temperatures. Thermogravimetric analysis (TGA) were employed to quantify carbonation products, analyze phase evolution, and characterize microstructural changes. Collectively, the results highlight the potential of CSA-based mixtures modified with reactive MgO, GGBFS, and wollastonite to deliver enhanced early-age strength, improved durability, and increased CO₂ uptake, supporting their use in low-carbon and resilient precast construction applications.

This Example introduces a significant advancement in sustainable concrete technology, specifically designed to meet the evolving performance and environmental demands of the precast construction industry. The developed concrete masonry unit integrates CSA cement with one or more mineral additives, reactive MgO, GGBFS, and wollastonite, each selected for its unique contribution to strength development, microstructural refinement, and environmental performance.

The combined use of these materials enables a synergistic effect that enhances early-age and long-term mechanical properties, while also addressing critical sustainability targets such as embodied carbon reduction and process energy efficiency. By leveraging the rapid-setting, low-limestone nature of CSA cement and the reactivity of MgO and other additives under CO₂-rich curing environments, this Example offers a transformative solution for next-generation precast systems.

The use of these alternative materials helps significantly mitigate the environmental impact traditionally associated with ordinary Portland cement-based concrete production. Among the most groundbreaking features of this system is its capacity for carbon dioxide (CO₂) sequestration during the curing process. Through the integration of CO₂ curing protocols, ranging from low to high concentrations, reactive phases such as MgO, GGBFS and wollastonite actively convert CO₂ into stable carbonates, contributing to measurable reductions in net carbon emissions. This approach not only lowers the carbon footprint of the cementitious mixture but also aligns with global decarbonization goals by enabling partial carbon capture and storage within the built environment. Together, the binder design and curing strategy form a robust, scalable pathway toward greener and more resilient construction materials.

The proportions of CSA cement and supplementary materials, including reactive MgO, GGBFS, and wollastonite, are carefully balanced to optimize mechanical performance, durability, and environmental impact. In various embodiments, MgO may be used at replacement levels ranging from more than 0% to about 40%, while CSA typically includes 60% to 100% of the total binder. GGBFS and wollastonite may each be incorporated at replacement levels ranging from approximately 10% to 30%. These tailored mix designs enable precise control over setting characteristics, early- and long-term strength development, durability performance, and CO₂ sequestration capacity, allowing for a harmonized balance between structural functionality and sustainability goals in precast concrete production.

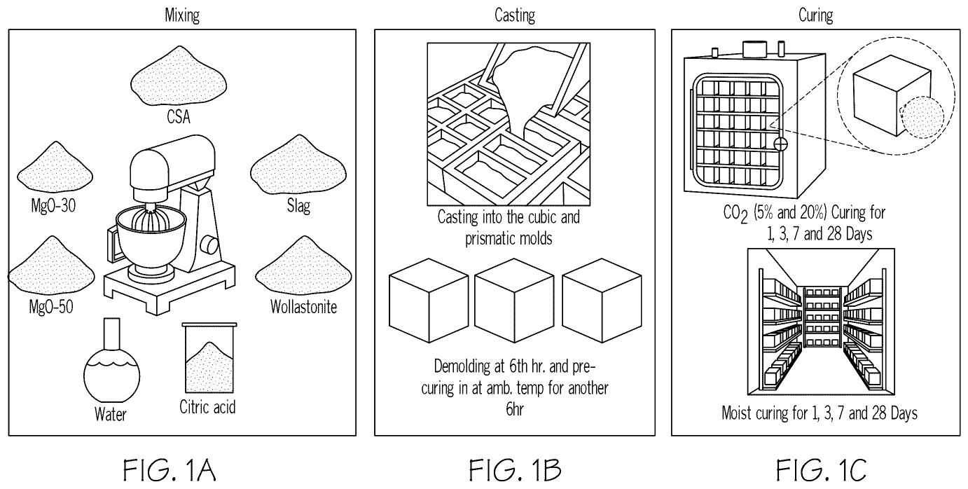

As illustrated in FIGS. 1A-1C, the mix preparation process incorporates high-purity, light-burned reactive MgO materials with specific surface areas ranging from approximately 10 m²/g to 60 m²/g to facilitate controlled carbonation and strength enhancement. A belitic calcium sulfoaluminate (BCSA) cement was used throughout, characterized by a defined composition that includes both ye′elimite and belite phases. In addition to MgO, the mix designs include GGBFS and wollastonite as supplementary materials, each selected for its ability to enhance specific performance attributes such as durability, carbonation efficiency, and matrix refinement. This mix design approach reflects a deliberate effort to achieve high early-age strength and long-term sustainability in masonry unit production.

The experimental methodology entails a comprehensive evaluation of multiple mix designs by systematically varying the replacement levels of reactive MgO, GGBFS, and wollastonite. MgO was incorporated at levels ranging from 0% to 40%, while GGBFS and wollastonite were each tested at replacement levels of 10%, 20%, and 30%, with the CSA cement content adjusted accordingly to maintain a total binder composition of 100%. This approach was designed to isolate the effects of each supplementary material on key performance parameters and to optimize both the mechanical properties and CO₂ sequestration potential of the cementitious mixtures.

The curing parameters, including CO₂ concentration, curing duration, temperature, and relative humidity, are recognized as pivotal factors influencing both the carbonation efficiency and the resulting properties of the cementitious mixtures. These variables directly affect the rate of CO₂ uptake, phase development, and strength evolution. In this Example, CO₂ curing was conducted using high-purity (99.9%) instrument-grade CO₂ at concentrations ranging from 0% to 20%. This range was selected to enable a systematic assessment of the carbon capture potential and performance response of CSA-based mixtures modified with MgO, GGBFS, and wollastonite under varying curing environments. The curing regimes were designed to simulate practical precast conditions and to evaluate the influence of CO₂ exposure on early-age and long-term material behavior.

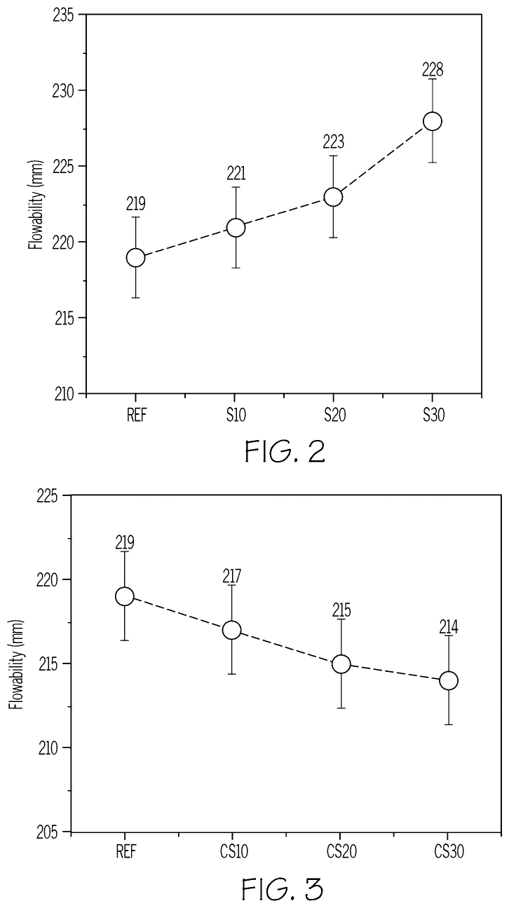

FIG. 2 presents flowability test results for CSA-based mortars modified with GGBFS at varying replacement levels. The flowability was assessed using standardized flow table procedures. The results indicate a consistent improvement in spread diameter with increasing slag content, suggesting enhanced workability relative to the reference CSA mix. These findings support the feasibility of slag incorporation to improve fresh-state performance in CSA-based cementitious systems.

FIG. 3 presents the flow table test results for CSA-based mortars modified with wollastonite at varying replacement levels. Compared to the reference CSA mix, a gradual decrease in flow diameter was observed with increasing wollastonite content. The reduction in flowability is attributed to the morphology of wollastonite particles. Nonetheless, all mixes remained within an acceptable workability range, indicating that wollastonite can be incorporated into CSA systems with minimal impact on fresh-state performance.

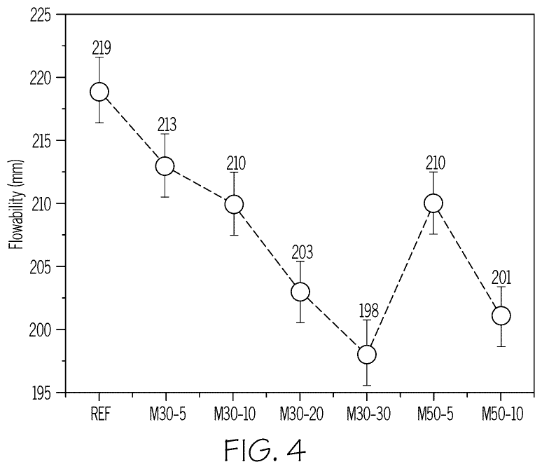

FIG. 4 presents flow table test results for CSA-based mortars modified with reactive MgO at various replacement levels and reactivity grades. Both standard (M30) and finer, more reactive (M50) MgO types were evaluated. A consistent reduction in flowability was observed with increasing MgO content, more pronounced in mixes containing finer MgO. The decline in workability is likely attributed to the higher surface area and reactivity of MgO compared to CSA cement. These results indicate that MgO incorporation affects fresh-state behavior and may require mix design adjustments to maintain desired workability in practical applications.

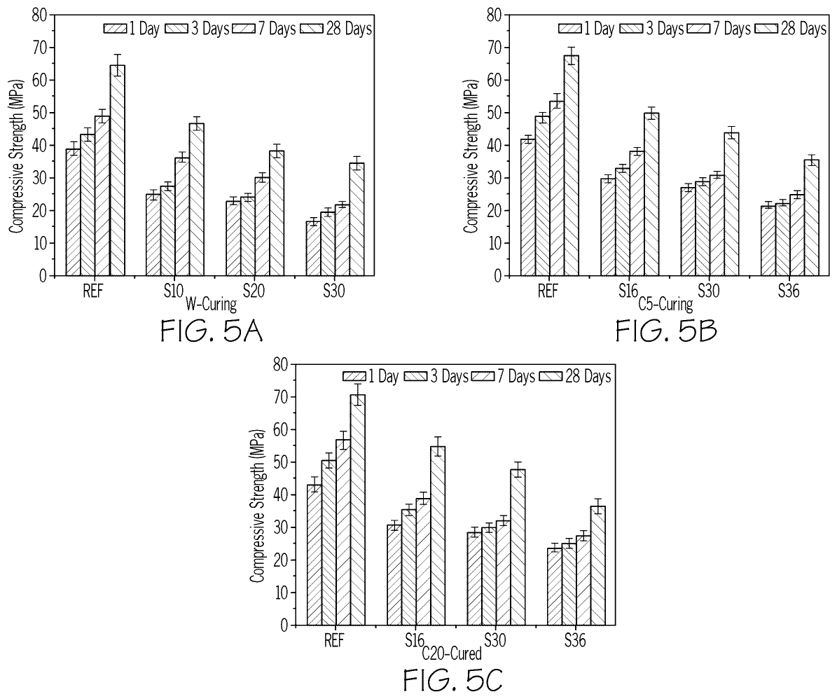

FIGS. 5A-5C present compressive strength test results for CSA-based mortars modified with GGBFS at 10%, 20%, and 30% replacement levels under water, 5% CO₂, and 20% CO₂ curing conditions. Under water curing, the 28-day strength of the reference mix reached 64.5 MPa, while slag-modified mixes showed reduced values, with S10 at 46.9 MPa, S20 at 38.3 MPa, and S30 at 34.7 MPa. CO₂ curing enhanced performance, particularly at 20% CO₂, where the S10 mix achieved 55.0 MPa, marking a 17.4% increase over its water-cured equivalent. While higher slag content continued to limit strength development, the results confirm that moderate slag incorporation combined with CO₂ curing improves compressive strength and supports its use in sustainable CSA-based systems.

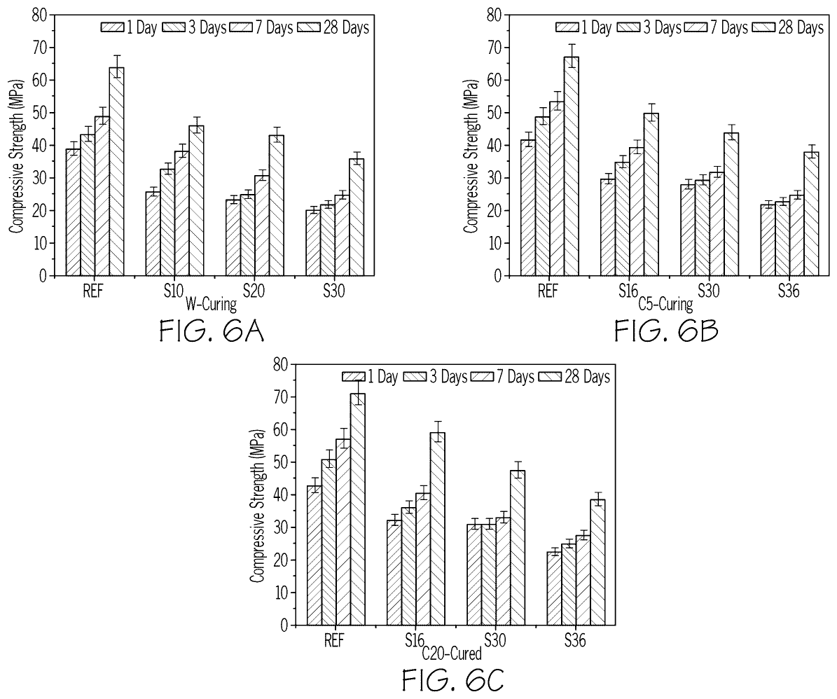

FIGS. 6A-6C present compressive strength results for CSA-based mortars modified with wollastonite at 10%, 20%, and 30% replacement levels under water, 5% CO₂, and 20% CO₂ curing conditions. Under water curing, the 28-day strength of the reference mix reached 64.5 MPa, while the wollastonite-modified mixes exhibited lower strengths, with CS10 at 46.4 MPa, CS20 at 43.6 MPa, and CS30 at 36.1 MPa. CO₂ curing significantly improved performance, especially under 20% CO₂ conditions, where the CS10 mix reached 59.0 MPa, a 27% increase over its water-cured counterpart. While higher wollastonite contents continued to reduce overall strength, the results demonstrate that wollastonite can contribute to compressive strength development in CSA systems under elevated CO₂ curing conditions through carbonation-induced matrix densification.

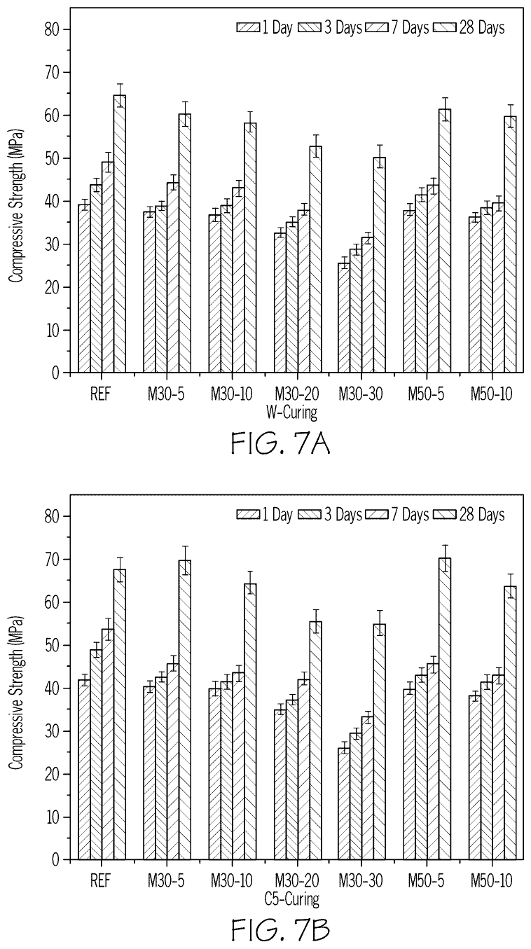

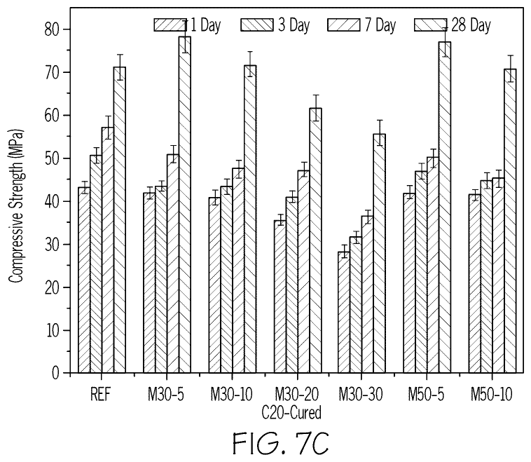

FIGS. 7A-7C present compressive strength results for CSA-based mortars modified with reactive MgO at various replacement levels and particle sizes under water, 5% CO₂, and 20% CO₂ curing conditions. Under water curing, the reference mix reached 62.3 MPa at 28 days, while mixes with moderate MgO content (5-10%) achieved comparable strengths, and higher MgO content (20-30%) resulted in reduced strength. CO₂ curing significantly enhanced strength performance.

Under 20% CO₂ curing, the mix with 5% MgO (M30-5-C20) achieved the highest strength of 77.7 MPa, surpassing the reference mix (71.1 MPa). Finer MgO (M50) further improved performance, with M50-5-C20 reaching 77.0 MPa. These results demonstrate that moderate levels of reactive MgO, particularly in combination with elevated CO₂ curing, enhance carbonation efficiency and matrix densification, leading to superior mechanical properties.

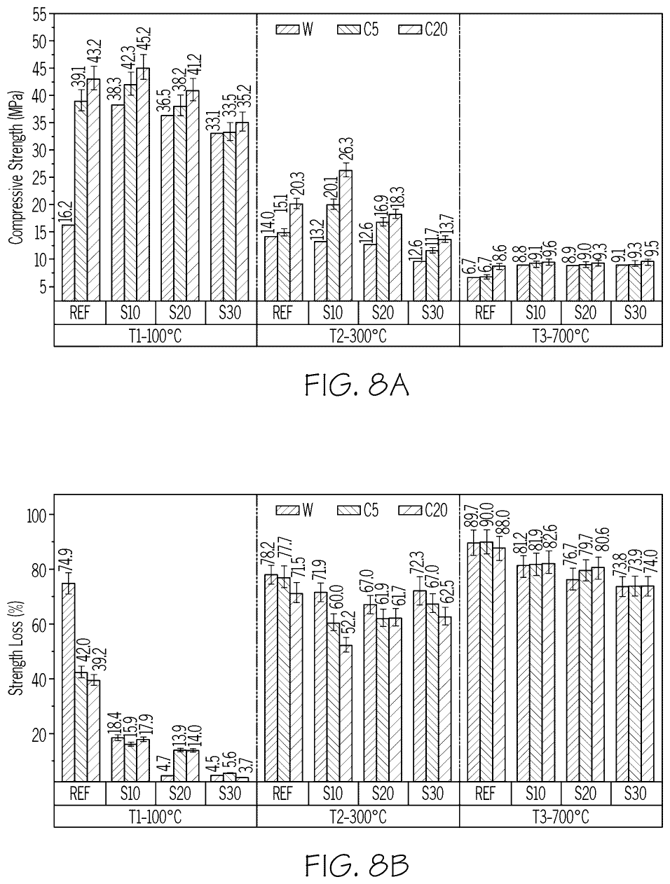

FIGS. 8A-8B present residual compressive strength and corresponding strength loss of CSA-based mortars modified with GGBFS after exposure to elevated temperatures of 100° C., 300° C., and 700° C. Across all temperatures, specimens cured in CO₂ environments, particularly at 20% CO₂, demonstrated enhanced thermal resistance compared to water-cured counterparts. At 100° C., REF-C20 retained 43.2 MPa, while S10-C20 achieved 45.2 MPa. At 300° C., slag-modified mixes such as S10-C20 maintained strength up to 26.3 MPa, representing a significant improvement over non-carbonated specimens. Even at 700° C., CO₂-cured slag-modified mortars retained higher residual strengths, with S10-C20 reaching 9.6 MPa. These results confirm that slag incorporation, combined with CO₂ curing, enhances the thermal stability of CSA mortars by promoting the formation of stable carbonate and low-porosity hydrated phases.

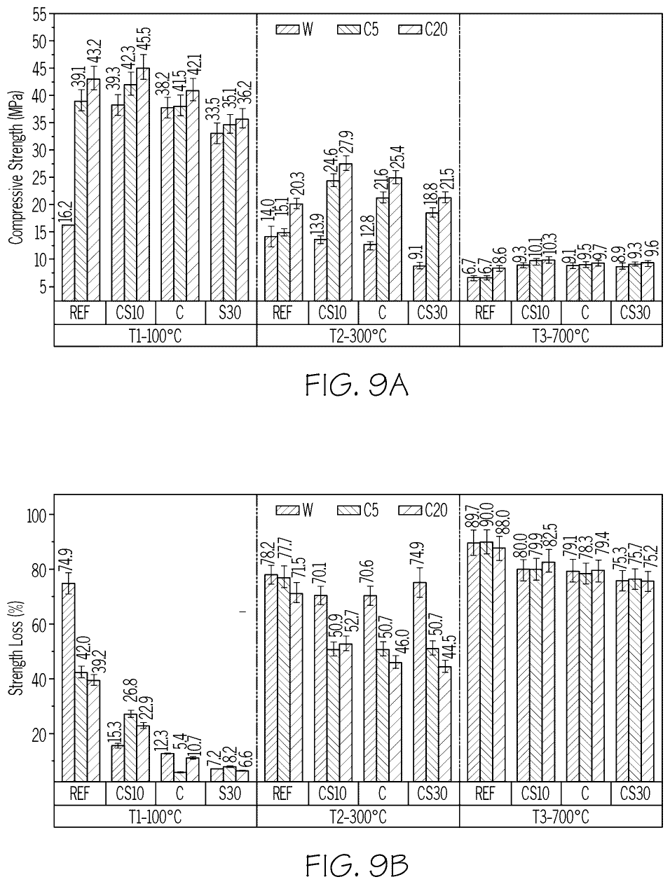

FIGS. 9A-9B present residual compressive strength and strength loss data for CSA-based mortars modified with wollastonite at 10%, 20%, and 30% replacement levels after exposure to 100° C., 300° C., and 700° C. At 100° C., CO₂-cured specimens outperformed water-cured ones, with CS10-C20 achieving the highest residual strength of 45.5 MPa. Wollastonite-modified mixes also retained more strength under water curing compared to the reference mix, indicating enhanced thermal stability even without carbonation. At 300° C., CS10-C20 reached 27.9 MPa, reflecting improved resistance to mid-temperature degradation. At 700° C., CS10-C20 maintained 10.3 MPa, higher than the reference under identical conditions. These results confirm that wollastonite, especially when combined with CO₂ curing, improves high-temperature performance in CSA mortars by stabilizing the matrix and promoting the formation of thermally resistant carbonate phases.

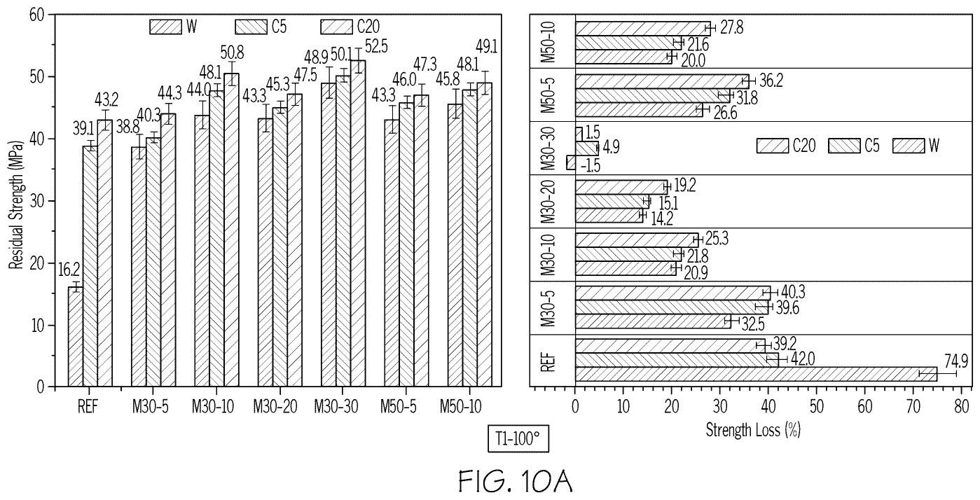

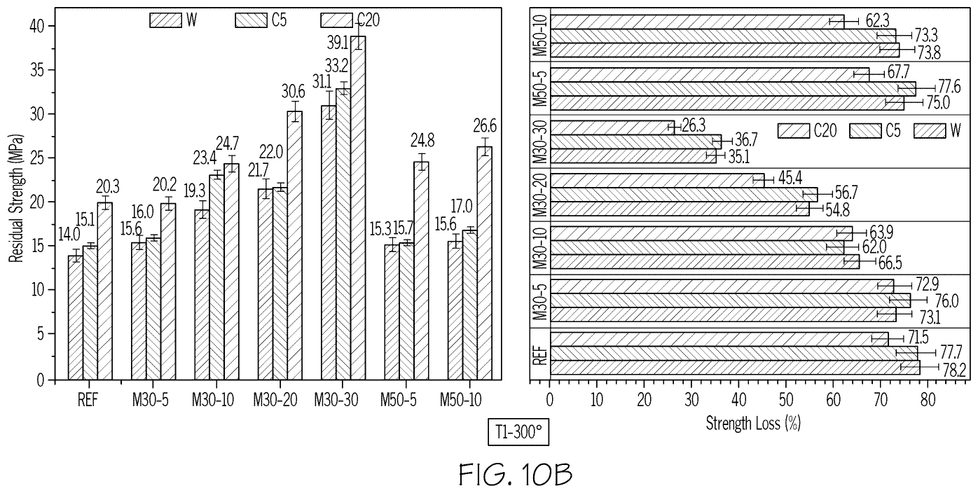

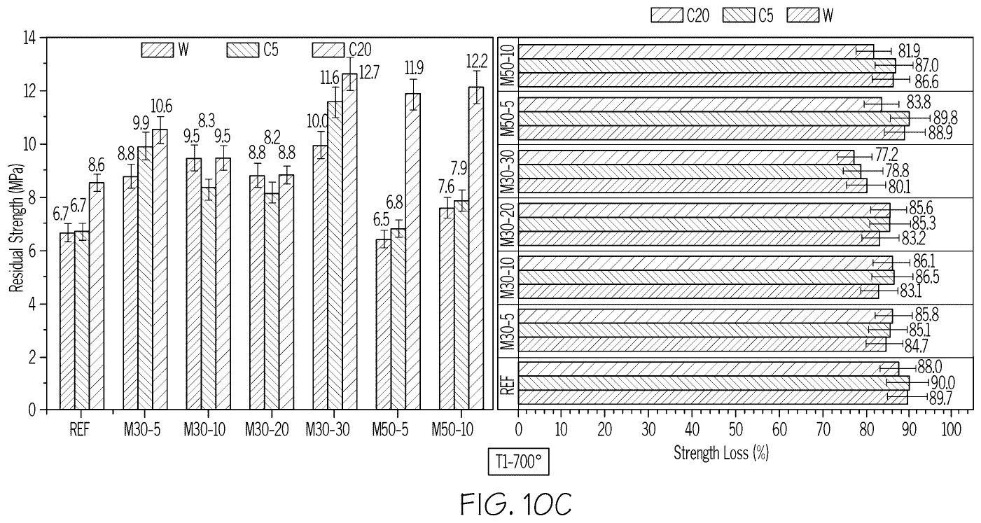

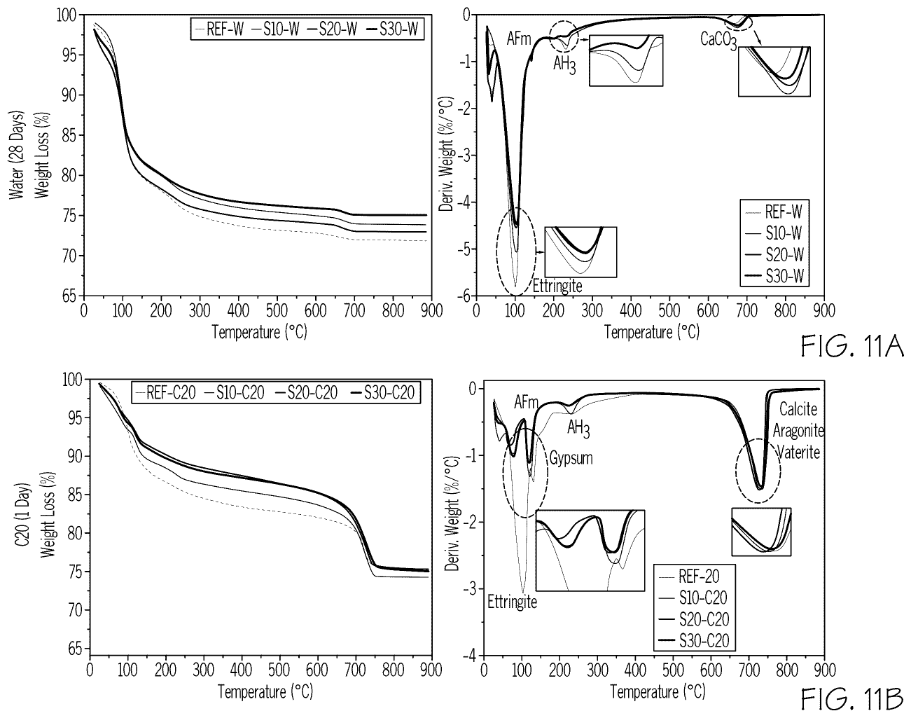

FIGS. 10A-10C present residual compressive strength and strength loss data for CSA-based mortars modified with reactive MgO after exposure to 100° C., 300° C., and 700° C. under water, 5% CO₂, and 20% CO₂ curing conditions. CO₂-cured specimens consistently exhibited higher thermal stability than water-cured mixes. At 100° C., the highest residual strength was recorded for M30-30-C20 at 52.5 MPa. At 300° C., M30-30-C20 again led performance with 39.1 MPa, while at 700° C., the same mix retained 12.7 MPa. Compared to water curing, CO₂ curing significantly reduced strength loss across all temperature levels. For example, at 700° C., M30-30-C20 showed a 77.2% strength loss, compared to 80.1% in M30-30-W. These results confirm that incorporating reactive MgO, particularly in conjunction with CO₂ curing, improves thermal resistance in CSA-based systems through the formation of thermally stable carbonate phases and enhanced microstructural integrity.

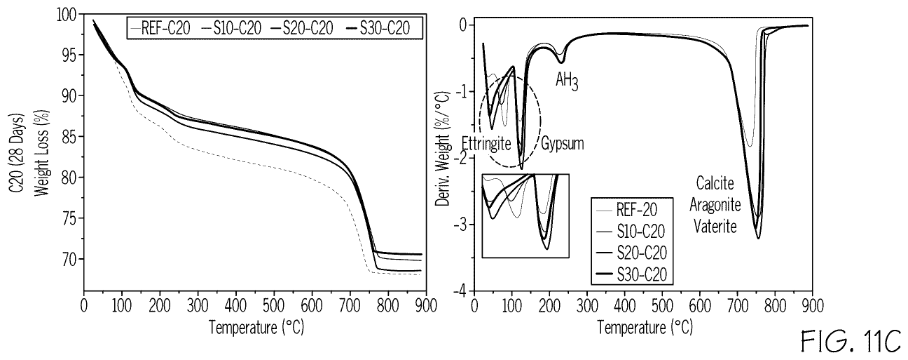

FIGS. 11A-11C present thermogravimetric (TGA) and derivative thermogravimetric (DTG) profiles of CSA-based mortars modified with GGBFS under water curing and 20% CO₂ curing conditions. At 28 days under water curing, limited weight loss is observed in the 600-900° C. range, indicating minimal carbonation. In contrast, specimens cured in 20% CO₂ show significant weight loss in this range, up to 14.3% for S20-C20, corresponding to the decomposition of calcium carbonate phases. The DTG curves further reveal reduced ettringite content in slag mixtures compared to the reference, alongside increased formation of gypsum and AH₃. As curing progresses from 1 to 28 days in CO₂-rich environments, slag-containing mixtures exhibit intensified carbonate peaks and reduced sulfate hydrate signatures, confirming accelerated carbonation and transformation of hydration phases. These results highlight that both slag content and elevated CO₂ exposure strongly influence the thermal decomposition behavior and carbonation degree in CSA-based systems.

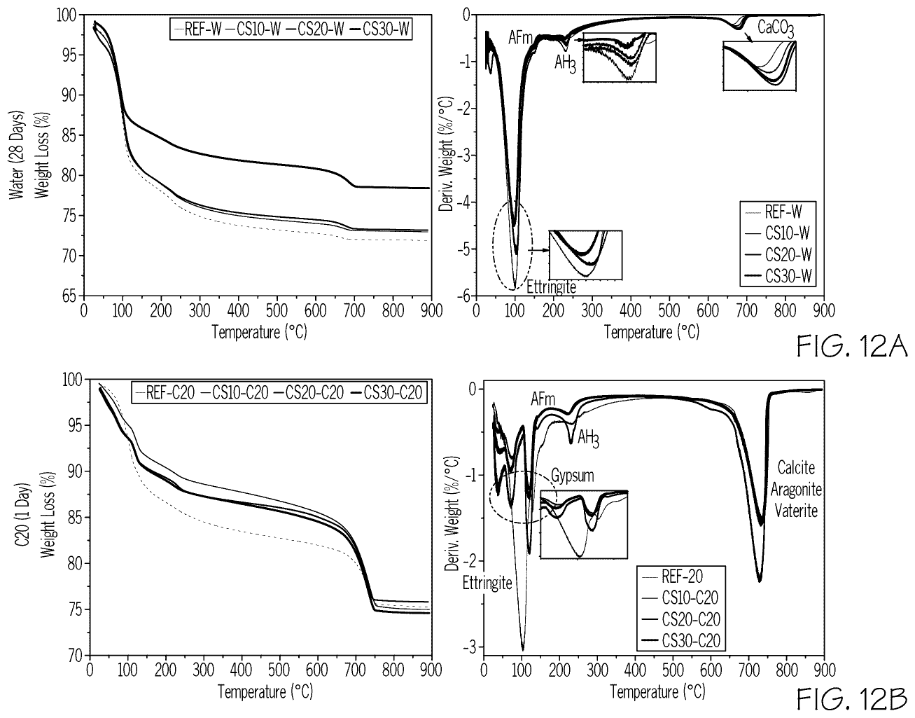

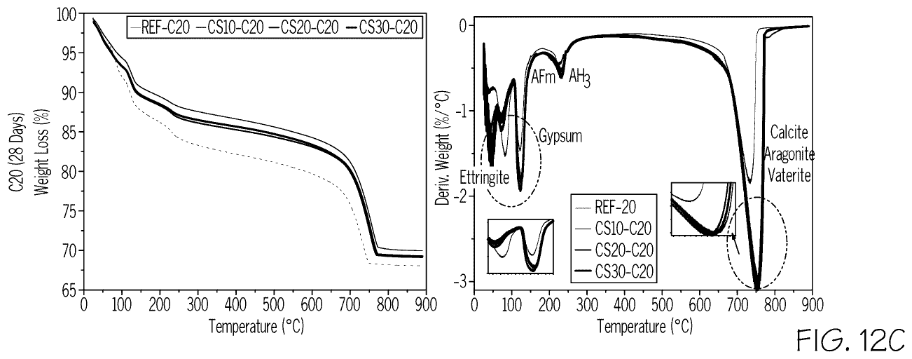

FIGS. 12A-12C present thermogravimetric (TGA) and derivative thermogravimetric (DTG) profiles of CSA-based mortars incorporating wollastonite at 10%, 20%, and 30% replacement levels, cured in water and under 20% CO₂ conditions for up to 28 days. Under water curing at 28 days, the ettringite decomposition peak (70-120° C.) shows a declining trend with increasing wollastonite content, indicating reduced formation of this phase. REF-W displays the highest weight loss (˜12%) while CS30-W shows the lowest (˜9.5%). The CaCO₃ decomposition between 600-900° C. is more pronounced in wollastonite-modified mixes, with CS20-W reaching 1.3% weight loss compared to 0.9% in REF-W. Under 20% CO₂ curing, early carbonation is evident by 1 day, with CS10-C20 showing the highest CaCO₃-related weight loss (10.5%) and a marked reduction in ettringite content. By 28 days, all wollastonite-modified specimens exhibit strong CaCO₃ decomposition signals (˜14%) with diminished ettringite and elevated gypsum formation (140° C.), particularly in CS20-C20 and CS30-C20. The DTG curves reveal a distinct peak near 50° C. exclusive to CO₂-exposed wollastonite mixes, suggesting unique phase evolution under elevated CO₂. The results indicate that wollastonite enhances carbonation and promotes gypsum and AH₃ formation while suppressing ettringite, with 20% CO₂ curing accelerating these transformations more than 5% CO₂.

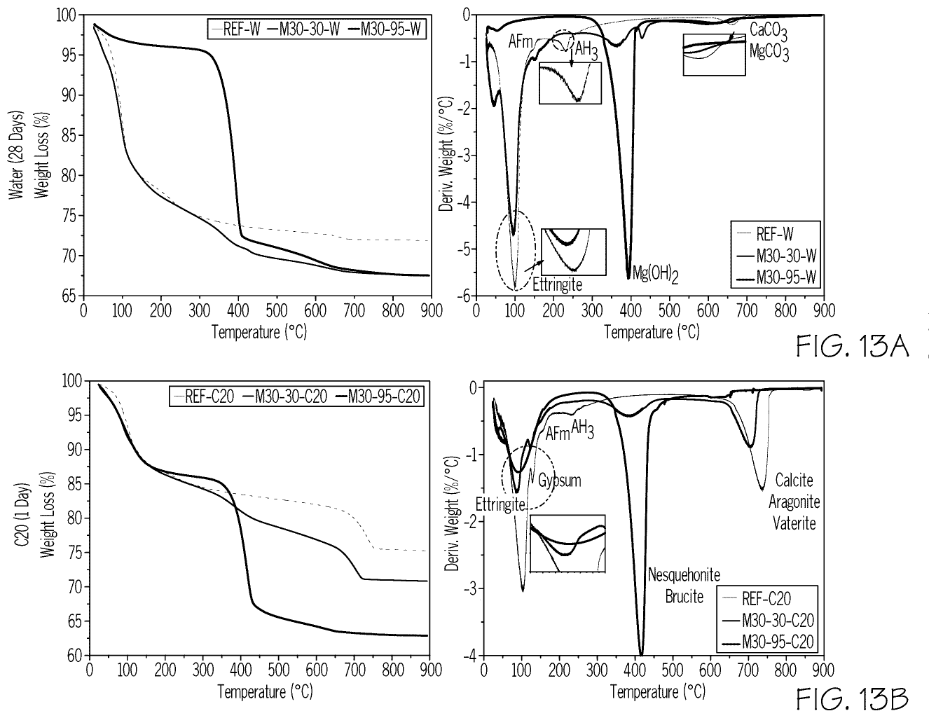

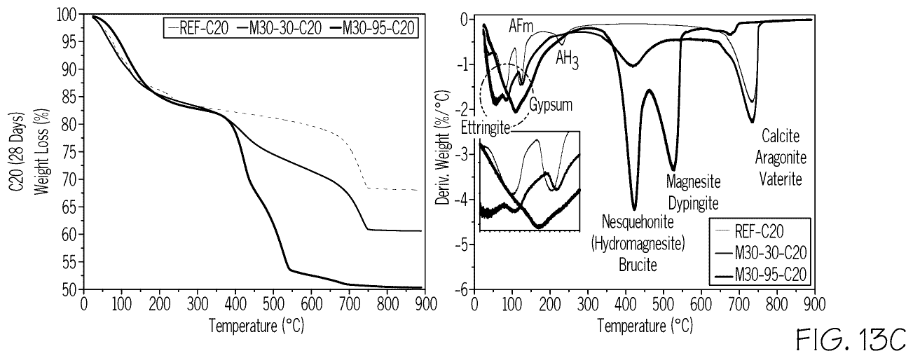

FIGS. 13A-13C present thermogravimetric (TGA) and derivative thermogravimetric (DTG) profiles of CSA-based mixtures modified with reactive MgO at various contents (5% to 95%) and surface areas (30 and 50 m²/g), cured in water and under 20% CO₂. In water-cured samples, ettringite decomposition is most intense in the reference CSA specimen (˜12% mass loss between 70° C. and 140° C.), diminishing with higher MgO content, indicating reduced AFt formation. A secondary peak near 250° C., attributed to AH₃, is observed in all mixes but is strongest in REF. Mg(OH)₂ decomposition, marked by a sharp peak near 400° C., becomes increasingly prominent in high-MgO systems such as M30-95, confirming the presence of magnesium hydrates. A CaCO₃ decomposition peak near 700° C. suggests some degree of carbonation in lower MgO mixes (e.g., M30-5, M30-10) under ambient exposure. CO₂ uptake measurements confirm that higher MgO content and finer particle size enhance carbonation under elevated CO₂ curing. At 28 days, M30-5-C20 reached a CO₂ uptake of 18.1%, while M50-5-C20 and M50-10-C20 exhibited uptakes of 18.7% and 19.2%, respectively. The highest uptake was recorded in M30-95-C20 at 28.2%. These trends highlight the role of MgO in promoting CO₂ mineralization, although diminishing returns are observed beyond moderate MgO levels. The results suggest that mixes with 5-10% MgO provide a favorable balance between CO₂ uptake and practical considerations such as workability and water demand.

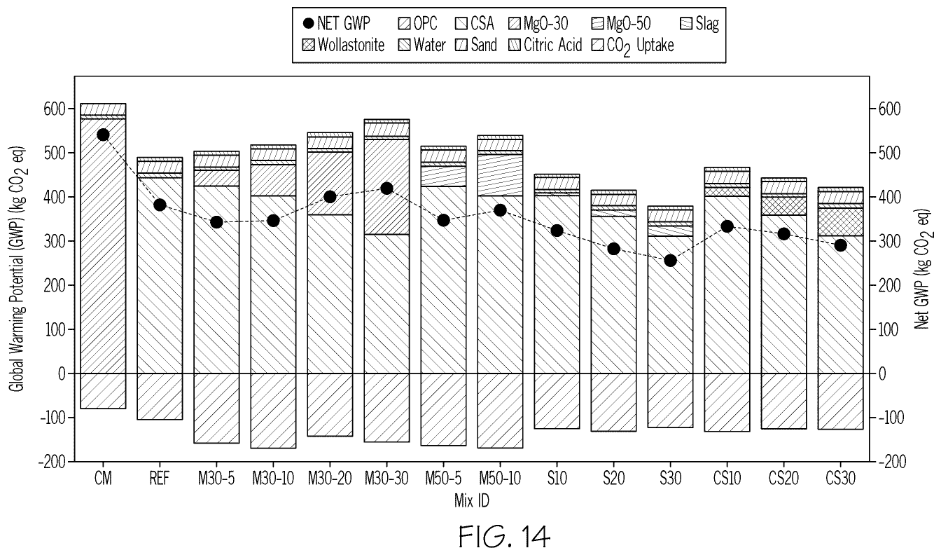

FIG. 14 illustrates the life cycle assessment (LCA) conducted using a cradle-to-gate approach with a functional unit of 1 m³ mortar. The assessment included ordinary Portland cement (OPC) and CSA-based mixtures incorporating reactive MgO, slag, and wollastonite as partial replacements. Inventory data were sourced from environmental product declarations (EPDs) and the Ecoinvent database, with MgO values supplemented from literature. The TRACI method was used to calculate Global Warming Potential (GWP), accounting for both emissions and CO₂ uptake through curing. As shown in FIG. 14, the OPC mix had the highest net GWP (528.5 kg CO₂ eq), while CSA reference mortar exhibited reduced emissions (379.7 kg CO₂ eq). Among alternatives, MgO-modified mixes such as M30-5 and M50-10 achieved net GWP values of 341.7 and 365.9 kg CO₂ eq, respectively, due to substantial CO₂ mineralization. Slag-modified CSA mortars demonstrated the lowest GWP, with S30 reaching 253.9 kg CO₂ eq. Wollastonite mixes provided moderate GWP reductions, with CS30 achieving a net GWP of 289.3 kg CO₂ eq. These results underscore the environmental advantages of CSA and alternative material use, particularly when optimized for both CO₂ uptake and mix performance.

Upon comparison, it becomes evident that the incorporation of alternative materials such as reactive MgO, slag, and wollastonite into CSA-based cementitious systems introduces distinct advantages in terms of both performance and sustainability. MgO-modified mixes demonstrated a clear trend of reduced workability with increasing content and fineness due to elevated surface area and water demand. However, they provided superior early-age strength and the highest CO₂ uptake, with M30-95 achieving up to 28.2% carbonation after 28 days. Slag-modified mixes maintained favorable workability and significantly reduced global warming potential, with S30 reaching the lowest net GWP at 253.9 kg CO₂ eq, making it ideal for applications focused on long-term sustainability. Wollastonite-modified mortars exhibited moderate reductions in workability and GWP but still achieved notable CO₂ sequestration and improved durability potential due to their unique acicular particle morphology. Thermogravimetric analysis further confirmed the evolving hydration and carbonation mechanisms with each additive, particularly the formation of Mg(OH)₂ and the decline in ettringite in high-MgO systems. The life cycle assessment results reaffirmed that all CSA-based alternatives outperform OPC in terms of net carbon footprint, primarily due to lower clinkerization temperatures, lower limestone usage, and enhanced capacity for CO₂ mineralization. These findings collectively demonstrate the potential of CSA-based systems, especially when tailored with specific SCMs, to achieve high-performance, carbon-efficient solutions that meet diverse construction requirements while addressing the pressing need for emissions reduction in the cement industry.

These detailed findings offer critical insights into the influence of CO₂ curing and reactive MgO incorporation on the performance of CSA-based mixtures, particularly at very early ages. The observed improvements in strength development and CO₂ uptake establish a strong foundation for further optimization and practical implementation in construction applications where early-age performance is essential.

The precast concrete industry, which relies heavily on rapid strength gain for prestressing operations, stands to benefit significantly from such a high-performance mix. The ability of the CSA-MgO, CSA-GGBFS and CSA-Wollastonite system to meet these early strength requirements positions it as a compelling solution for this sector. Given the continued expansion of the precast concrete market, this Example demonstrates strong commercial relevance and considerable potential for widespread adoption.

Overall, this Example represents a significant breakthrough in sustainable construction materials, offering enhanced performance, reduced carbon footprint, and long-term durability. The detailed experimentation and optimization processes provide a robust foundation for the commercialization and widespread adoption of this Example in the construction industry, contributing to global efforts for achieving net-zero emissions.

The proposed Example introduces a novel cementitious system combining CSA cement with reactive MgO, GGBFS, and wollastonite, offering a comprehensive approach to improving both the environmental profile and early-age performance of mortar and concrete materials. This formulation significantly departs from conventional practices by not only enhancing CO₂ uptake through accelerated carbonation but also addressing the early strength requirements critical for precast applications.

While MgO serves as a reactive phase for CO₂ mineralization and strength gain, slag contributes to long-term durability and reduced embodied carbon, and wollastonite provides a balance between reactivity and dimensional stability. The synergistic use of these materials within CSA-based systems has not been previously documented in the context of CO₂ curing and performance optimization. To the Applicant's knowledge, no prior disclosure or existing patent demonstrates this integrated use of MgO, slag, and wollastonite in CSA matrices for achieving high CO₂ sequestration capacity alongside early strength development under low-carbon curing regimes. This innovation establishes a new pathway for producing sustainable, high-performance cementitious materials particularly suited for the growing needs of the precast and low-carbon construction sectors.

This Example represents a substantial advancement in overcoming key challenges within the precast concrete industry, particularly the demand for cementitious systems capable of delivering high early-age strength under accelerated curing conditions. By integrating CSA cement with reactive MgO, slag, and wollastonite, the formulation not only enhances early performance but also achieves considerable reductions in net global warming potential through CO₂ mineralization. The combined benefits of rapid strength gain, lower embodied carbon, and compatibility with CO₂ curing align well with the operational priorities of precast manufacturing, such as reduced turnaround times and sustainability targets. As such, the Example demonstrates significant potential to transform both the technical performance and environmental impact of cement-based materials in modern construction.

The significance of the Example arises from the deliberate combination of CSA cement with reactive MgO, GGBFS and wollastonite, each possessing distinct physicochemical properties that introduce complexity and innovation to the formulation. CSA cement, known for its rapid strength development and lower calcination temperature, behaves differently from MgO, which varies in particle fineness, reactivity, and CO₂ affinity. Slag, in turn, offers latent hydraulic behavior and contributes to long-term strength and durability while reducing environmental impact. These materials differ in particle size distributions, specific surface areas, mineral compositions, and hydration kinetics, making their collective performance under CO₂ curing conditions highly non-intuitive. The interactions among these components are not straightforward, and predicting the synergistic effects, particularly regarding early strength gain, durability, and CO₂ uptake, would not be evident to a person skilled in the art. This multifaceted system introduces a novel approach to designing high-performance, low-carbon cementitious materials suitable for demanding applications such as precast concrete.

Additionally, the specific conditions required for effective CO₂ curing and early-age strength development introduce further complexities when incorporating reactive MgO, GGBFS, and wollastonite into CSA cement systems. Prior to this Example, the combined use of CSA cement with these alternative materials, each possessing distinct reactivity profiles, mineralogical characteristics, and carbonation behaviors-had not been documented in the context of CO₂ capture and performance enhancement for precast applications. The observed synergistic interactions, particularly under elevated CO₂ curing conditions, were unexpected and cannot be predicted by simply considering the behavior of each component in isolation. These findings demonstrate that the integration of MgO, GGBFS, and wollastonite with CSA cement leads to a unique and effective material system, advancing both early-age strength development and carbon sequestration, and highlighting the originality and industrial relevance of the proposed Example.

Overall, the Example represents a significant departure from conventional approaches, offering a unique and unexpected solution to longstanding challenges in the cement industry. The Example addresses several critical problems faced by the construction industry, particularly those encountered by precast companies requiring high early-age strength materials.

Firstly, this Example addresses the urgent need to reduce greenhouse gas emissions associated with cement production by incorporating alternative materials such as reactive MgO, GGBFS, and wollastonite into CSA cement. These materials not only reduce the embodied carbon of the mix but also facilitate enhanced CO₂ sequestration during curing, particularly under elevated CO₂ conditions. This dual benefit of lower initial emissions and increased CO₂ uptake contributes significantly to environmental sustainability. The approach is especially valuable for precast concrete manufacturers aiming to meet sustainability targets without compromising early-age performance and durability, positioning this Example as a compelling solution for low-carbon, high-performance construction applications.

Secondly, this Example provides tangible benefits in terms of material performance, including enhanced early-age strength development and improved durability. Precast companies depend on mixtures that achieve rapid strength gain to streamline production schedules and meet demanding timelines. The CSA-based blends incorporating reactive MgO, GGBFS, and wollastonite fulfill this need by delivering superior early-age strength, especially under CO₂ curing conditions. These enhanced performance characteristics enable faster demolding and earlier installation of precast elements, ultimately increasing productivity, reducing construction timelines, and providing a more durable and resilient end product.

In addition, this Example aligns with growing market demands for sustainable construction materials. As environmental performance becomes a key priority across the construction sector, there is increasing demand for materials that reduce carbon emissions while maintaining or improving durability and strength. The CSA-based systems incorporating reactive MgO, GGBFS, and wollastonite meet this need by offering lower embodied carbon and significant CO₂ uptake during curing, without compromising mechanical performance. These attributes make the Example especially attractive to precast companies seeking durable, high-strength, and environmentally responsible alternatives to traditional cement-based materials.

Overall, the Example offers a practical solution to pressing challenges faced by the precast concrete industry, particularly the demand for high early-age strength materials that also support environmental sustainability. By incorporating CSA cement with reactive MgO, GGBFS, and wollastonite, the system provides a synergistic approach that enhances strength development, enables CO₂ mineralization, and significantly lowers the embodied carbon of cementitious mixtures. This combination addresses both performance and sustainability requirements, positioning the Example as a valuable innovation for precast manufacturers, infrastructure developers, and regulatory agencies focused on advancing low-carbon construction practices.

While other technologies exist in the market offering sustainable concrete solutions, this Example delivers several distinct practical and competitive advantages through the integration of CSA cement with reactive MgO, GGBFS, and wollastonite.

High early-age strength. The CSA-based formulation, especially when combined with MgO, provides enhanced early-age strength development, which is desirable for precast operations. This enables faster demolding, shorter curing cycles, and accelerated construction schedules.

Lower carbon footprint. The use of CO₂ curing alongside CSA, MgO, slag, and wollastonite significantly reduces the carbon footprint of the resulting masonry units. These materials contribute to CO₂ mineralization while replacing clinker-intensive components, aligning with stringent sustainability goals and decarbonization strategies.

Versatility. The system supports a wide range of applications, including façade panels, partition walls, carbon-conscious masonry blocks, architectural components, paving units, retaining elements, utility vaults, and modular precast systems. Its tunable setting behavior and CO₂ uptake capacity provide flexibility to meet diverse project specifications.

Enhanced performance. Continuous experimental validation demonstrates superior long-term durability, improved resistance to chemical attack, and overall stability across varying environmental conditions. These attributes make this Example well-suited for demanding construction scenarios, further distinguishing it from conventional and alternative low-carbon solutions.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A cement mixture comprising:
calcium sulfoaluminate (CSA); and
an additive selected from the group consisting of magnesium oxide (MgO), ground granulated blast-furnace slag (GGBFS), wollastonite, and combinations thereof.

2. The cement mixture of claim 1, wherein the CSA is present in the mixture at a concentration ranging from about 60 wt. % to less than about 100 wt. %.

3. The cement mixture of claim 1, wherein the additive comprises MGO.

4. The cement mixture of claim 3, wherein the MgO is present in the mixture at a concentration ranging from more than 0 wt. % to about 40 wt. %.

5. The cement mixture of claim 3, wherein the MgO comprises surface areas ranging from about 10 m²/g to about 60 m²/g.

6. The cement mixture of claim 1, wherein the additive comprises GGBFS.

7. The cement mixture of claim 6, wherein the GGBFS is present in the mixture at a concentration ranging from about 10 wt. % to about 30 wt. %.

8. The cement mixture of claim 1, wherein the additive comprises wollastonite.

9. The cement mixture of claim 8, wherein the wollastonite is present in the mixture at a concentration ranging from about 10 wt. % to about 30 wt. %.

10. The cement mixture of claim 1, wherein the cement mixture further comprises one or more aggregate materials.

11. The cement mixture of claim 10, wherein the aggregate materials comprise sand.

12. The cement mixture of claim 1, further comprising a cement retarder.

13. The cement mixture of claim 12, wherein the cement retarder comprises citric acid.

14. A cementitious material comprising a cement mixture, wherein the cement mixture comprises:
calcium sulfoaluminate (CSA); and
an additive selected from the group consisting of magnesium oxide (MgO), ground granulated blast-furnace slag (GGBFS), wollastonite, and combinations thereof.

15. The cementitious material of claim 14, wherein the cementitious material is in cured form.

16. The cementitious material of claim 14, wherein the cementitious material is in the form of mortars, concrete, precast masonry units, or combinations thereof.

17. The cementitious material of claim 14, wherein the cementitious material is in the form of concrete.

18. The cementitious material of claim 14, wherein the additive comprises MGO.

19. The cementitious material of claim 14, wherein the additive comprises GGBFS.

20. The cementitious material of claim 14, wherein the additive comprises wollastonite.

21. A method of forming a cementitious material, said method comprising:
mixing calcium sulfoaluminate (CSA) with an additive to form a mixture, wherein the additive is selected from the group consisting of magnesium oxide (MgO), ground granulated blast-furnace slag (GGBFS), wollastonite, and combinations thereof; and
curing the mixture, wherein the curing occurs in the presence of carbon dioxide (CO₂).

22. The method of claim 21, wherein the mixing further comprises mixing the mixture with one or more aggregate materials.

23. The method of claim 22, wherein the aggregate materials comprise sand.

24. The method of claim 21, wherein the mixing further comprises mixing the mixture with one or more cement retarders.

25. The method of claim 24, wherein the cement retarder comprises anhydrous citric acid.

26. The method of claim 21, wherein the CO₂ concentration is at least about 5%.

27. The method of claim 21, wherein the method is used to capture CO₂ from an environment.

28. The method of claim 21, wherein the additive comprises MGO.

29. The method of claim 21, wherein the additive comprises GGBFS.

30. The method of claim 21, wherein the additive comprises wollastonite.
